(19) United States
(12) Patent Application Publication
(10) Pub. No.: US 2018/0274702 A1
(43) Pub. Date: Sep. 27, 2018

(54) METHOD OF MAKING A CRIMP CONNECTION

(71) Applicant: PAUL D. JACKSON, VICTORIA, VA (US)

(72) Inventor: PAUL D. JACKSON, VICTORIA, VA (US)

(21) Appl. No.: 15/920,668

(22) Filed: Mar. 14, 2018

Related U.S. Application Data
(60) Provisional application No. 62/475,425, filed on Mar. 23, 2017.

(51) Int. Cl. F16L 13/14

(52) U.S. Cl. CPC F16L 13/141

(57) ABSTRACT

A method of making a crimp connection comprises sliding a crimp ring over a female end of a pipe or tube, the crimp ring having an oval shape; inserting a male end of a fitting into the female end of the pipe or tube; sliding the crimp ring toward the fitting such that the crimp ring at least partly overlaps the inserted male end of the fitting; and applying a compressive force to an exterior surface of the crimp ring. Prior to applying the compressive force, the crimp ring has a first inner diameter and a second inner diameter transverse to the first inner diameter. The first inner diameter is greater than the second inner diameter. The first inner diameter is greater than an outer diameter of the pipe or tube. The second inner diameter is less than the outer diameter of the pipe or tube.

### CROSS-REFERENCE TO RELATED APPLICATIONS

This application claims priority to pending U.S. Provisional Application Ser. No. 62/475,425, filed Mar. 23, 2017, the contents of which are incorporated herein by reference in its entirety.

### FIELD OF THE INVENTION

The present invention relates generally to pipes, such as for plumbing, and devices and methods for connecting a pipe

### BACKGROUND

Pipes for carrying water and other liquids are constructed of many different types of materials, such as different metals and different plastics. One popular type of pipe is crosslinked polyethylene, also known as PEX. Pipes are connected to other pipes, fixtures, appliances, and the like, using many different devices and methods, which often vary depending on the type of pipe. (While embodiments of the invention are described herein in relation to pipe and piping, embodiments of the invention may also be used with tubes and tubing and any other similar devices that are connected with crimp rings as described herein.)

Referring now to FIGS. 1 and 2, a conventional device and method for connecting a pipe is illustrated. FIG. 1 illustrates an end view of a pipe 10, which may be a PEX pipe (or any other suitable type of pipe or tubing or the like), and an end view of a separate crimp ring 12. The crimp ring 12 is constructed of a metal or metal alloy, such as copper, brass, etc. Both the conventional pipe 10 and the conventional crimp ring 12 are circular. The pipe 10 comes in a variety of standard sizes, such as ¼ inch, ⅜ inch, ½ inch, ¾ inch, one inch, etc., which is typically based on the inner diameter (ID) of the pipe. The outer diameter (OD) of the pipe will vary depending on the ID and the thickness of the pipe. The crimp ring that is used to connect a pipe has an ID that corresponds to the OD of the pipe. That is, the ID of the crimp ring is slightly larger than the OD of the corresponding pipe such that the crimp ring slides easily on the pipe. The relative sizes of the pipe 10 and the crimp ring 12, and the spacing therebetween, are exaggerated for clarity in FIGS. 1 and 2.

To connect a pipe 10 to a fitting (as an example), the crimp ring 12 is slid over the end of the pipe 10 that is to be attached to the fitting. FIG. 2 is an end view of the crimp ring 12 in position over the pipe 10. The male end of the fitting is inserted into the attachment end of the pipe 10. The crimp ring 12 is then slid toward the attachment end of the pipe 10 (if necessary) until the crimp ring 12 is aligned with the inserted male end of the fitting to the position recommended by the manufacturer. A crimp tool is then positioned on the crimp ring 12 and activated (typically be squeezing together two handles) such that the crimp tool applies a squeezing pressure around the perimeter of the crimp ring 12 (indicated by the dashed line arrows in FIG. 2). The crimp tool circumferentially compresses the crimp ring 12 against the pipe 10 which in turn circumferentially compresses the pipe 10 against the male end of the fitting, thereby forming a watertight connection between the pipe 10 and the fitting.

While this crimping method of attaching a pipe has many advantages over other conventional methods (such as soldering and gluing), the crimping method has at least one disadvantage. When connecting a pipe, it is difficult to maintain the crimp ring in the desired position as the crimp ring tends to move along the pipe when positioning the crimp tool. This tendency of the crimp ring to move is especially pronounced when connecting the top end of a vertical pipe. If the crimp ring moves even a little out of position, this can prevent a proper watertight connection.

### BRIEF SUMMARY OF THE DISCLOSURE

In one embodiment of the invention, a method of making a crimp connection comprises sliding a crimp ring over a female end of a pipe or tube, the crimp ring having an oval shape; inserting a male end of a fitting into the female end of the pipe or tube; sliding the crimp ring toward the fitting such that the crimp ring at least partly overlaps the inserted male end of the fitting; and applying a compressive force to an exterior surface of the crimp ring.

Prior to applying the compressive force, the crimp ring has a first inner diameter and a second inner diameter transverse to the first inner diameter. The first inner diameter is greater than the second inner diameter. The first inner diameter is greater than an outer diameter of the pipe or tube. The second inner diameter is less than the outer diameter of the pipe or tube.

Alternative embodiments of the invention may comprise a crimp ring as described herein. Further alternative embodiments of the invention may comprise a crimp ring as described herein and a corresponding crimp tool.

### BRIEF DESCRIPTION OF THE SEVERAL VIEWS OF THE DRAWINGS

Reference will now be made to the accompanying drawings, which are not necessarily drawn to scale. The following detailed description of the disclosure will be better understood when read in conjunction with the appended drawings. It should be understood, however, that the disclosure is not limited to the precise arrangements and instrumentalities shown. In the drawings:

FIG. 1 is an end view of a conventional pipe and a separate conventional crimp ring.

FIG. 2 is an end view of the conventional pipe and conventional crimp ring of FIG. 1, in position for attachment.

FIG. 3 is an end view of a crimp ring, in accordance with embodiments of the present invention.

FIG. 4 is an end view of the conventional pipe and the crimp ring of FIG. 3, in position for attachment.

FIG. 5 is a side view of a conventional pipe and conventional fitting, in position for attachment, with the crimp ring of FIG. 3 in its pre-attachment position.

FIG. 6 is a side view of a conventional pipe and conventional fitting and the crimp ring of FIG. 3, in position for attachment.

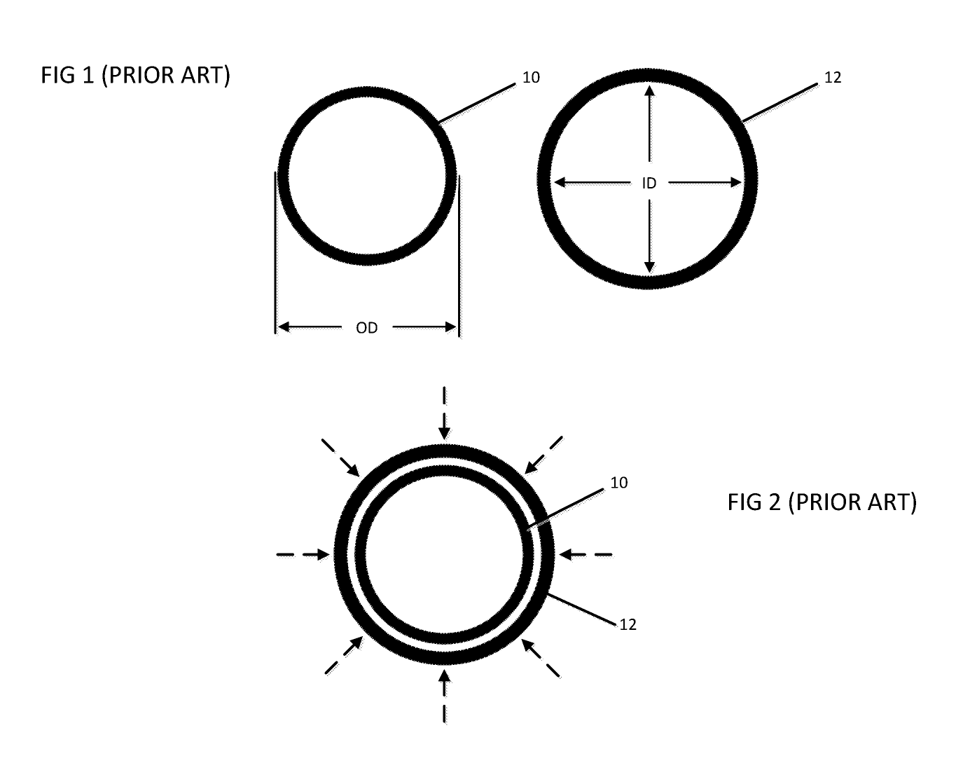

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention are directed to a crimp ring and method of connecting a pipe, tube, etc. to a fitting or the like using a crimp ring. The crimp ring of embodiments of the invention may also be termed a compression ring, and includes any band that is adapted to encircle a pipe, tubing, or the like and, via the application of a squeezing, compressing, crimping, etc. force, is compressed against the outer perimeter of the pipe or tubing to secure the pipe or tubing to a fitting having a male end inserted into the pipe or tubing. The pipe, tubing, etc. may be PEX tubing or any other suitable type of pipe, tubing, or the like that is capable of being joined to a fitting or other pipe, tubing, etc. via a crimp connector. The fitting may be any suitable fitting that has at least one male end insertable into a female end of the pipe, tubing, or the like. As just one example, the fitting may be a male-male fitting for joining two female pipe or tubing ends.

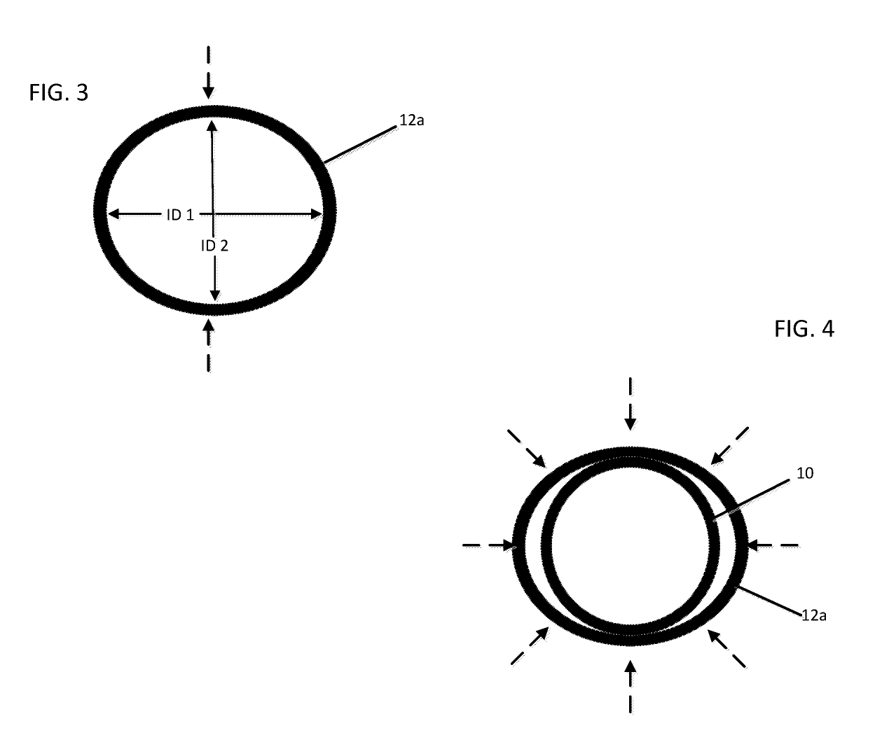

Referring now to FIGS. 3-6, a crimp ring 12a is illustrated in accordance with embodiments of the invention. As seen in FIG. 3, the crimp ring 12a is oval rather than the conventional circular crimp ring. As such, the crimp ring 12a does not have a uniform ID. The longest ID (ID 1) is perpendicular to the shortest ID (ID 2). The shape and size of the crimp ring 12a is selected such that ID 2 is slightly less than the OD of the corresponding pipe 10 and that ID 1 is slightly greater than the OD of the corresponding pipe. (The difference between the longest ID (ID 1) of the oval crimp ring and the OD of the corresponding pipe is typically greater than the difference between the ID of the conventional circular crimp ring the OD of the corresponding pipe. This is particularly true if the oval crimp ring 12a is created by compressing opposing sides of a conventional circular crimp ring, as described below.) This relationship between the IDs of the crimp ring 12a and the OD of the pipe is illustrated in FIG. 4. The relative sizes of the pipe 10 and the crimp ring 12a, and the spacing therebetween, are exaggerated for clarity in FIGS. 3 and 4.

The shortest ID (ID 2) of the crimp ring 12a is selected such that sufficient friction is created between the closest opposing sides of the crimp ring 12a and the pipe 10 when the crimp ring 12a is positioned on the pipe 10 in order to keep the crimp ring 12a in place even if the pipe 10 is vertical. However, the friction created between the closest opposing sides of the crimp ring 12a and the pipe 10 when the crimp ring 12a is positioned on the pipe 10 should not be so great that the crimp ring 12a cannot be readily repositioned by hand on the pipe 10.

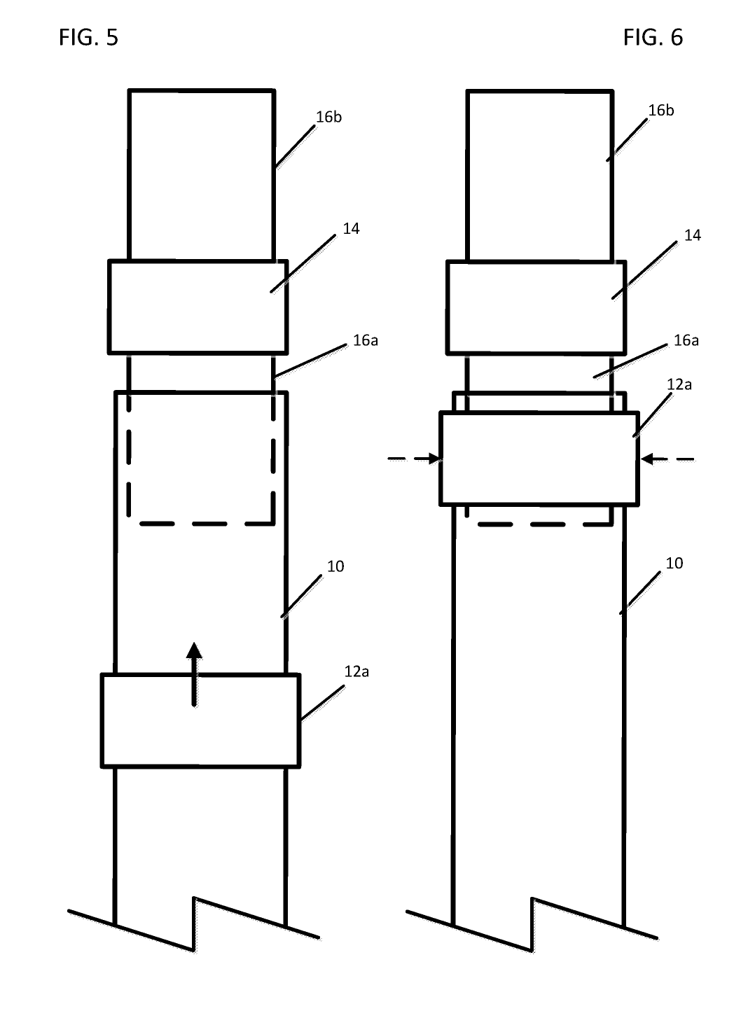

FIGS. 5 and 6 illustrate the crimping process, showing an exemplary crimp connection between a pipe or tubing 10 and a fitting 14. Fitting 14 is a male-male connector with a first male end 16a and a second male end 16b. The crimp ring 12a has an oval shape as described above. FIG. 5 shows the crimp ring 12a having been slid over the female end of the pipe 10. The crimp ring 12a is preferably slid at least a few inches down the pipe 10 and away from the end to be crimped (the exact distance is not important). The oval shape of the crimp ring helps retain the crimp ring in the desired positions (such as the position shown in FIG. 5 and the position shown in FIG. 6), even if the pipe is vertical as illustrated in FIGS. 5 and 6. The first male end 16a is inserted into the female end of the pipe 10 (the dashed line of the first male end 16a illustrates it being within the pipe 10). The crimp ring 10 is then slid toward the fitting 14 (as illustrated by the solid line arrow) such that the crimp ring 12a at least partly overlaps the inserted first male end 16a of the fitting 14. The correct position of the crimp ring 12a for crimping is shown in FIG. 6. A compressive force is then applied to an exterior surface of the crimp ring 12a (illustrated by the dashed line arrows).

The crimp ring of embodiments of the invention may be constructed of any suitable material that can hold the desired oval shape prior to crimping and that can hold its compressed (i.e., crimped) shape after crimping, such as a metal or metal alloy (e.g., copper, brass, stainless steel, etc.). The crimp ring 12a can be constructed having the desired oval shape from stock tubing that already has the desired oval shape. Alternatively, a conventional circular crimp ring can be converted into an oval crimp ring of embodiments of the invention by applying a compressing force to opposing sides of the conventional circular crimp ring to decrease the ID in one direction (which will increase the ID in a transverse direction). This compressing force is illustrated by the dashed line arrows in FIG. 3. In one specific embodiment of the invention, a conventional circular crimp ring was compressed in this manner such that the ID in one direction decreased by 0.5 mm and increased in the transverse direction by 0.5 mm.

The size relationship between the shortest ID of the crimp ring and the OD of the pipe necessary to create the desired amount of friction may vary depending on, for example, the size of the crimp ring, the size of the pipe, the material of the crimp ring, and/or the material of the pipe. As such, some experimentation may be necessary to obtain the correct size relationship for a specific combination of crimp ring and pipe.

The same method may then be used to crimp an oval crimp ring of embodiments of the invention to connect a pipe. The oval crimp ring 12a is slid over the end of the pipe 10 to be attached to the fitting. FIG. 4 is an end view of the crimp ring 12a in position over the pipe 10. The male end of the fitting is inserted into the attachment end of the pipe 10. The crimp ring 12a is then slid toward the attachment end of the pipe 10 (if necessary) until the crimp ring 12a is aligned with the inserted male end of the fitting. The friction between the crimp ring 12a and the pipe 10 will advantageously maintain the position of the crimp ring 12a while the crimp tool is positioned on the crimp ring 12. The crimp tool is activated (typically be squeezing together two handles) such that the crimp tool applies a squeezing pressure around the perimeter of the crimp ring 12a (indicated by the dashed line arrows in FIG. 4). The crimp tool circumferentially compresses the crimp ring 12a against the pipe 10 which in turn circumferentially compresses the pipe 10 against the male end of the fitting, thereby forming a watertight connection between the pipe 10 and the fitting.

The oval shape of the crimp ring 12a is completely reversed by the crimping process such that the crimp ring 12a is crimped and forms a watertight connection in the same manner as the conventional circular crimp ring.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method of making a crimp connection, the method comprising:
sliding a crimp ring over a female end of a pipe or tube, the crimp ring having an oval shape;
inserting a male end of a fitting into the female end of the pipe or tube;
sliding the crimp ring toward the fitting such that the crimp ring at least partly overlaps the inserted male end of the fitting; and
applying a compressive force to an exterior surface of the crimp ring.

2. The method of claim 1, wherein, prior to applying the compressive force, the crimp ring has a first inner diameter and a second inner diameter transverse to the first inner diameter;
wherein the first inner diameter is greater than the second inner diameter;
wherein the first inner diameter is greater than an outer diameter of the pipe or tube; and
wherein the second inner diameter is less than the outer diameter of the pipe or tube.
